(19) United States
(12) Patent Application Publication
(10) Pub. No.: US 2010/0083476 A1
(43) Pub. Date: Apr. 8, 2010

(54) ASSEMBLING MACHINE

(76) Inventor: Alessio Brusa, Lugo (IT)

Correspondence Address: TUTUNJIAN + BITETTO, P.C., 20 CROSSWAYS PARK NORTH, SUITE 210, WOODBURY, NY, 11797, US

(21) Appl. No.: 12/443,521

(22) PCT Filed: Dec. 27, 2006
(86) PCT No.: PCT/IB06/03776

§ 371 Date: Nov. 6, 2009

(30) Foreign Application Priority Data
Sep. 28, 2006 (IT) BO2006A000667

(51) Int. Cl. B23Q 1/00

(52) U.S. Cl. 29/283.5

(57) ABSTRACT

A machine for assembling modular markers, in particular markers for identifying electric cables or the like, includes tags and supporting elements. The supporting elements have respective housings designed to accommodate the labeled elements. The machine comprises a mechanism for inserting the tags into the housings.

### TECHNICAL FIELD

This invention relates to a machine for assembling modular markers, in particular markers for identifying electric cables or the like.

### RELATED ART

In the electrical industry, it is usual to identify electric cables with markers so that the cables can be connected to the correct terminals.

For this purpose, whereas in small or simple electrical systems the electric cables can be identified using sheaths of different colours, in large or complex systems, this type of identification is inadequate because different coloured sheaths are not available in sufficient numbers.

The markers used in large or complex systems comprise support rings available on the market, for example, in the form of a continuous transparent tube. These support rings, viewed in cross section, comprise a substantially ring-shaped fixing portion that supports a tubular housing.

The ring-shaped fixing portion is designed to be fitted around an electric cable, while the tubular housing is designed to accommodate a tag that is pre-printed with one or more symbols, such as, for example, alphanumeric characters defining a desired identification label.

The tag, which is substantially in the shape of a parallelepiped with rectangular base, may be made of plastic or other suitable material.

At present, markers are assembled manually by an operator.

The operator has to pick up a support ring substantially equal in length to the tag and then inserts the latter manually into the tubular housing. This manual operation is very slow and laborious and may lead to errors.

### SUMMARY

This invention has for an aim to provide an automatic machine for assembling modular markers, in particular markers for identifying electric cables or the like.

The invention accordingly provides a machine for assembling modular markers, in particular markers for identifying electric cables or the like, comprising tags and supporting elements, said supporting elements having respective housings designed to accommodate the tags, characterised in that the machine comprises means for inserting the tags into the housings.

The assembling machine may also comprise means for cutting the supporting to elements, with the tags inserted in them, to a desired length.

The invention permits the production of an automatic machine for assembling a plurality of markers quickly and accurately.

### BRIEF DESCRIPTION OF THE DRAWINGS

The invention can be better understood and implemented with reference to the accompanying drawings which illustrate a non-limiting example embodiment of it and in which:

FIG. 1 is an axonometric view of a machine for assembling modular markers;

FIG. 2 is a schematic front view of a marker;

FIG. 3 is a schematic side view of the marker of FIG. 2;

FIG. 4 is a schematic top view of the marker of FIG. 2;

FIG. 5 is a schematic interrupted side view of a tube of supporting elements forming part of the marker of FIG. 2;

FIG. 6 is a side view of the assembling machine of FIG. 1;

FIG. 7 is a front view, with some parts cut away to better illustrate others, of the assembling machine of FIG. 1;

FIG. 8 is a front view of inserting means forming part of the assembling machine of FIG. 1;

FIG. 9 is a front view of guide means forming part of the assembling machine of FIG. 1;

FIG. 10 is an axonometric view of the guide means of FIG. 9;

FIG. 11 is a top view of the guide means of FIG. 9;

FIG. 12 is a side view of the inserting means of FIG. 8;

FIG. 13 is an axonometric view of the inserting means of FIG. 8;

FIG. 14 is a top view of the inserting means of FIG. 8;

FIG. 15 is a front view of supporting means forming part of the assembling machine of FIG. 1;

FIG. 16 is a side view of the supporting means of FIG. 15;

FIG. 17 is a top view of the supporting means of FIG. 15;

FIG. 18 is an axonometric view of the supporting means of FIG. 15;

FIG. 19 is a front view of positioning means forming part of the assembling machine of FIG. 1;

FIG. 20 is a side view of the positioning means of FIG. 19;

FIG. 21 is a front view of cutting means forming part of the assembling machine of FIG. 1;

FIG. 22 is an axonometric view of the cutting means of FIG. 21;

FIG. 23 is a top view of the cutting means of FIG. 21;

FIG. 24 is a top view, with some parts cut away to better illustrate other parts, of the assembling machine of FIG. 1 in a first operating configuration;

FIG. 25 is a top view, with some parts cut away to better illustrate other parts, of the assembling machine of FIG. 1 in a second operating configuration;

FIG. 26 is a top view, with some parts cut away to better illustrate other parts, of the assembling machine of FIG. 1 in a third operating configuration;

FIG. 27 is a top view, with some parts cut away to better illustrate other parts, of the assembling machine of FIG. 1 in a fourth operating configuration;

FIG. 28 is a top view, with some parts cut away to better illustrate other parts, of another embodiment of the cutting means of the assembling machine of FIG. 1.

### DETAILED DESCRIPTION OF PREFERRED EMBODIMENTS

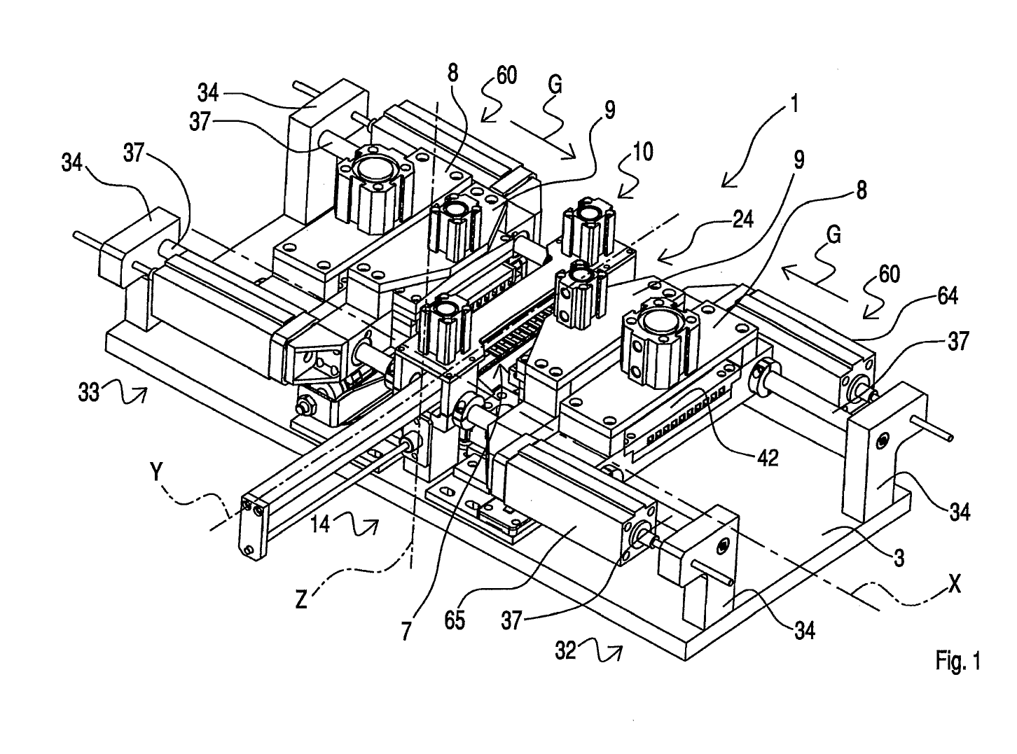

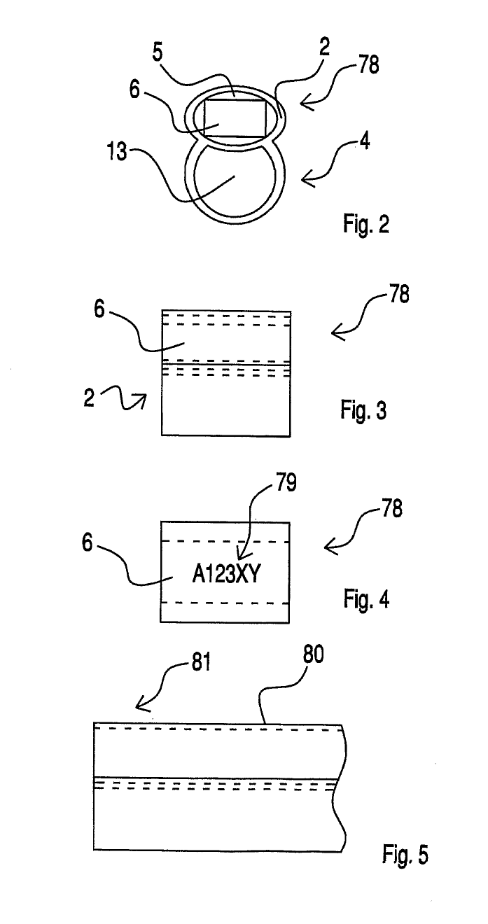

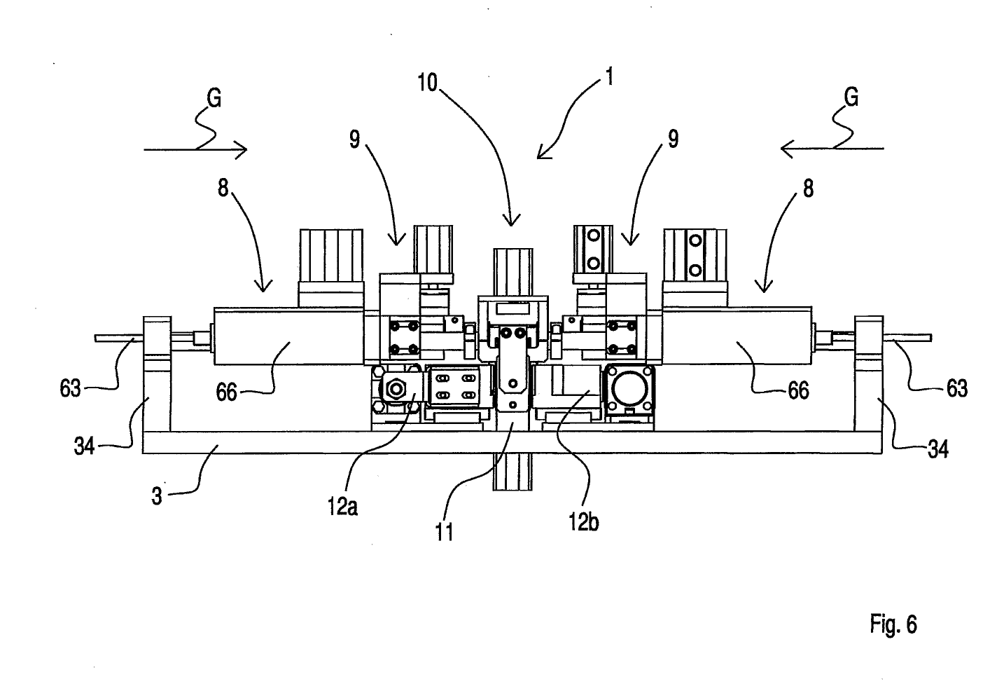

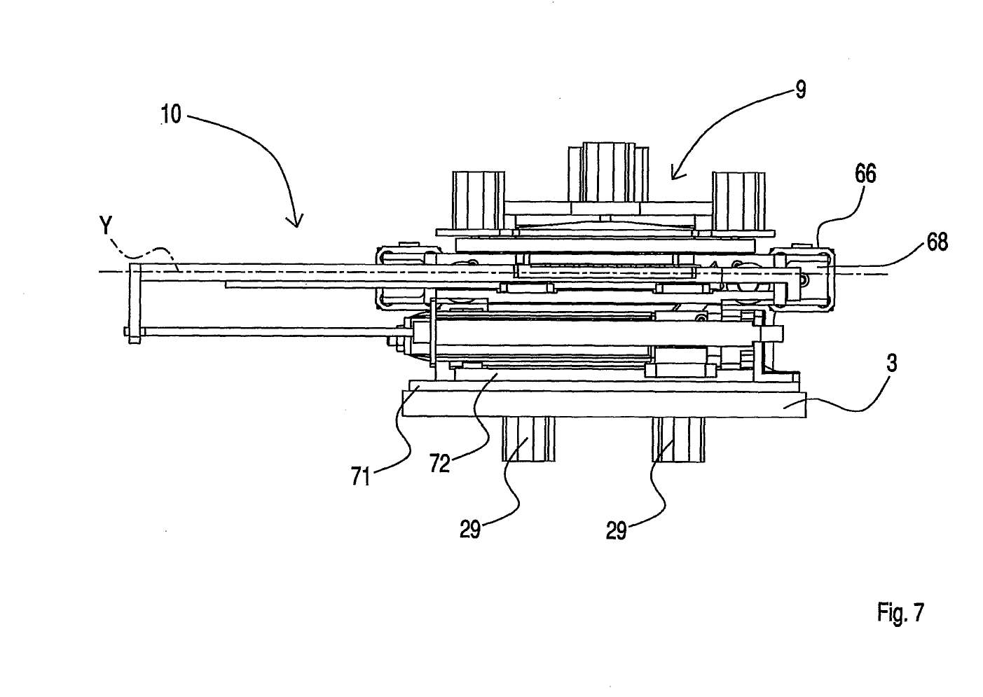

FIGS. 1 to 7 illustrate a machine 1 for assembling modular markers 78, in particular markers 78 for identifying electric cables or the like.

The markers 78 comprise supporting elements 2 available on the market, for example in the form of a continuous transparent tube 80. Each supporting element 2 comprises a tubular housing 5 and a substantially ring-shaped fixing portion 4 with a cavity 13. The fixing portion 4 is designed to be fitted around or slipped on an electric cable, while the housing 5 is designed to accommodate a tag 6 that has been pre-printed by a printer or other suitable device with one or more symbols 79, such as, for example, alphanumeric characters defining a desired identification label. The tags 6, that are substantially in the shape of a parallelepiped with rectangular base, may be grouped in strips 7, available on the market, and may be made of plastic or other suitable material.

The assembling machine 1 comprises a frame 3 extending along a first axis X and having the shape of a parallelepiped with a rectangular base. The frame 3 comprises an intermediate portion 14 mounting supporting means 10 and positioning means 11 for supporting and positioning the tag strips 7, respectively.

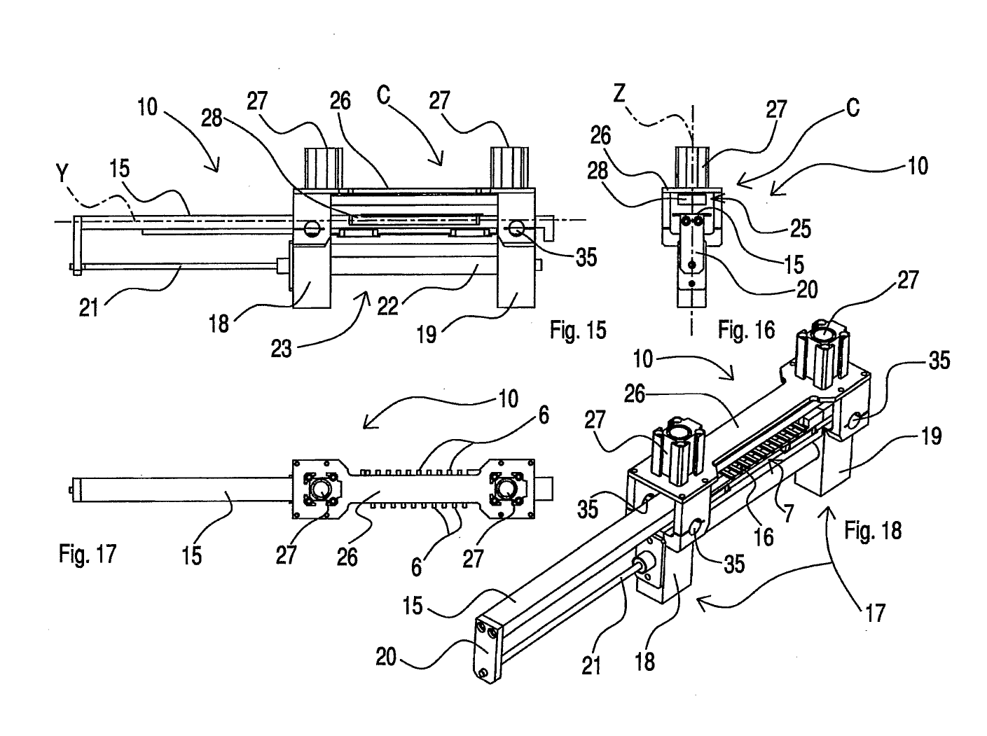

The supporting means 10, shown in FIGS. 15 to 18, extend along a second axis Y substantially perpendicular to the first axis X, and have a supporting structure 17 comprising, at opposite ends of it, a first support 18 and a second support 19 being substantially in the shape of a Y.

The first support 18 and the second support 19 extend along a third, substantially vertical axis Z and each comprises a pair of first holes 35 extending in a direction parallel to the first axis X (FIGS. 15 and 18). The first support 18 and the second support 19 are designed to support a mounting element 15. The mounting element 15 is substantially in the shape of a parallelepiped with rectangular base and has a seat 16 for accommodating the strip 7. The mounting element 15 is associated, through a connecting plate 20, with first drive means 23.

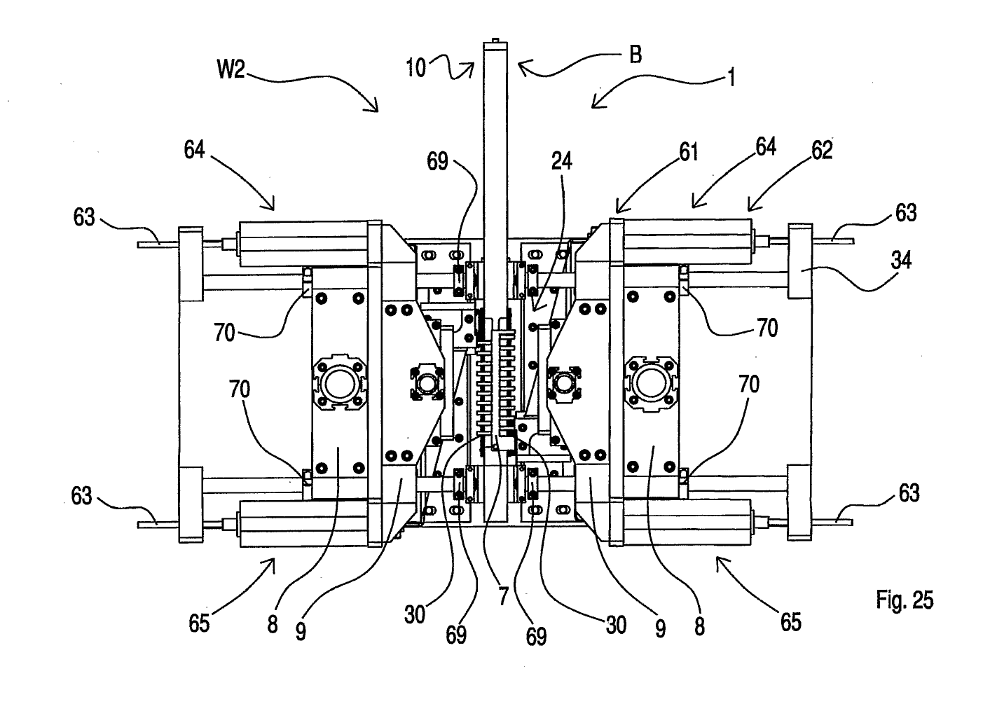

The first drive means 23 comprises a rod 21 that slides in a cylinder 22 under the action of an actuator, not illustrated, for example, a pneumatic actuator. The first drive means 23 are designed to move the mounting element 15 along the second axis Y between a first working position A, shown in FIG. 24, and a second working position B, shown in FIGS. 25 to 27.

More specifically, in the first working position A, it is possible to insert into the seat 16 a strip 7 of tags 6 without the supporting elements 2, or to remove from the seat 16 a strip 7 after the tags 6 have been inserted into the supporting elements 2, as described below.

In the second working position B, on the other hand, the strip 7 is positioned in a working area 24 in which the markers 78 can be assembled, as described below. The supporting means 10 also comprises a first crossbar 26 extending along the second axis Y and having associated with it a pair of first actuators 27, for example, pneumatic actuators. The first actuators 27 are associated with, and designed to move, retaining means 25 designed to engage/release the strip 7 when the supporting means 10 are in the second working position B.

The retaining means 25 comprises a presser 28 which, when the supporting means 10 are in the second working position B, faces the strip 7. The presser 28 is mobile between a first released position C, shown in FIGS. 15 to 18, and a first engaged position, not illustrated, for releasing/engaging the strip 7, respectively. In other words, in the first engaged position, the presser 28 is in contact with the strip 7 and keeps it pressed against the respective seat 16, whilst in the first released position C, the presser 28 is raised relative to the strip 7.

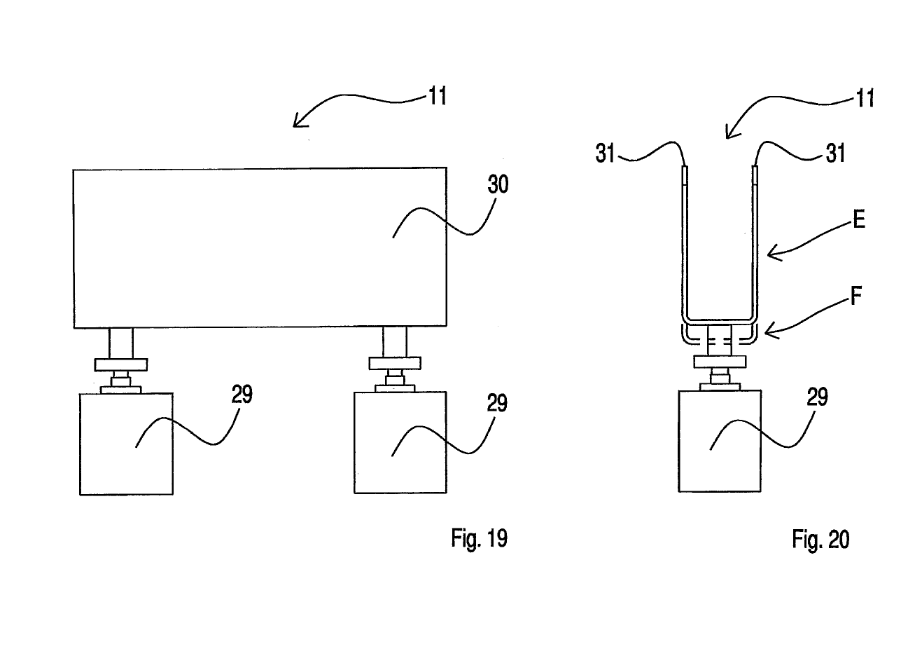

The positioning means 11, illustrated in FIGS. 19 and 20 is operatively positioned under the supporting means 10. The positioning means 11 are designed to place the tags 6 of the strip 7 in a suitable position in the working area 24. More specifically, if one of the tags 6 on the strip 7 is bent downwards, the positioning means 11 line it up in such a way that each of the tags 6, in the appropriate operating step, faces a respective housing 5 in the tubes 80.

Even if a tag 6 on the strip 7 is bent upwards, the presser 28 lines it up it in such a way that each of the tags 6 faces a respective housing 5 in the tubes 80. The positioning means 11 comprises a pair of second actuators 29, for example pneumatic actuators. The second actuators 29 are associated with a positioning element 30 and are designed to move the latter along an axis substantially parallel to the third axis Z between a raised position E and a lowered position F (drawn with a dashed line) in which the positioning element 30 is, respectively, in contact with, or at a certain distance from, the tags 6 on the strip 7.

Looking in more detail, the positioning element 30 is substantially U-shaped and, at its ends, has substantially co-planar contact portions 31 designed to come into contact with the tags 6 on the strip 7. The frame 3 also comprises a first end portion 32 and a second end portion 33 with which respective pairs of supports 34, each being substantially in the shape of an upturned L, are associated. Each support 34 comprises a second hole 36 facing the corresponding first hole 35 made in the supporting means 10. Thus, each first hole 35 and second hole 36 pair cooperates to support a sliding rod 37 extending along the first axis X. Each pair of rods 37 is in turn designed to slidably support guide means 8 and inserting means 9 of the assembling machine 1.

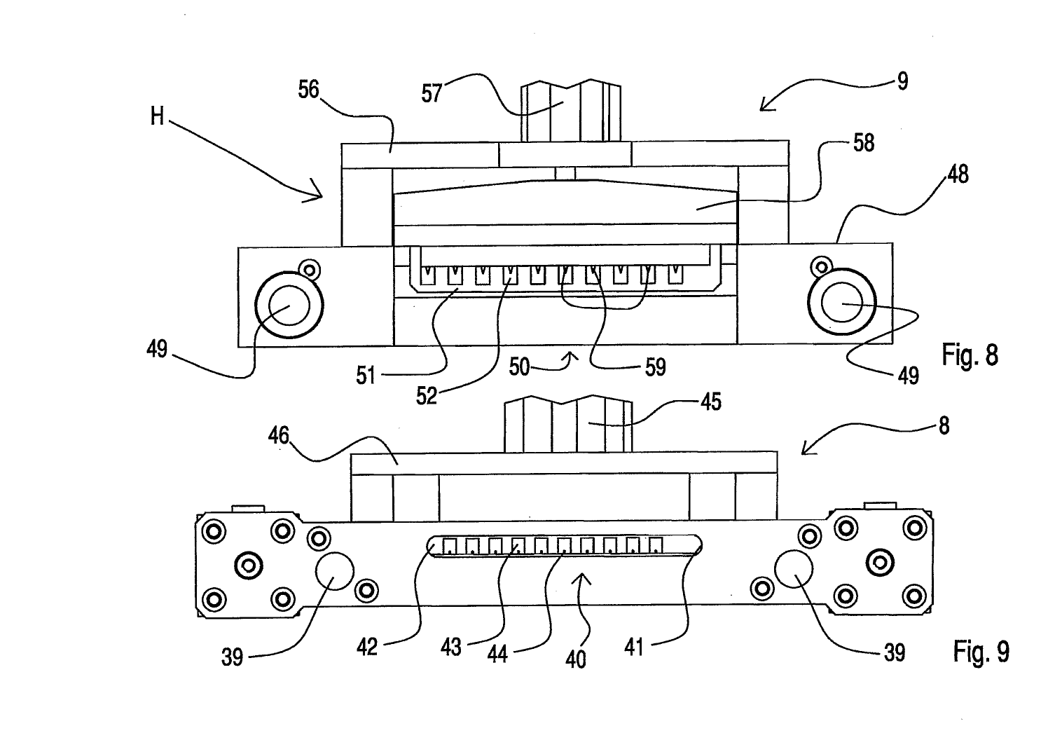

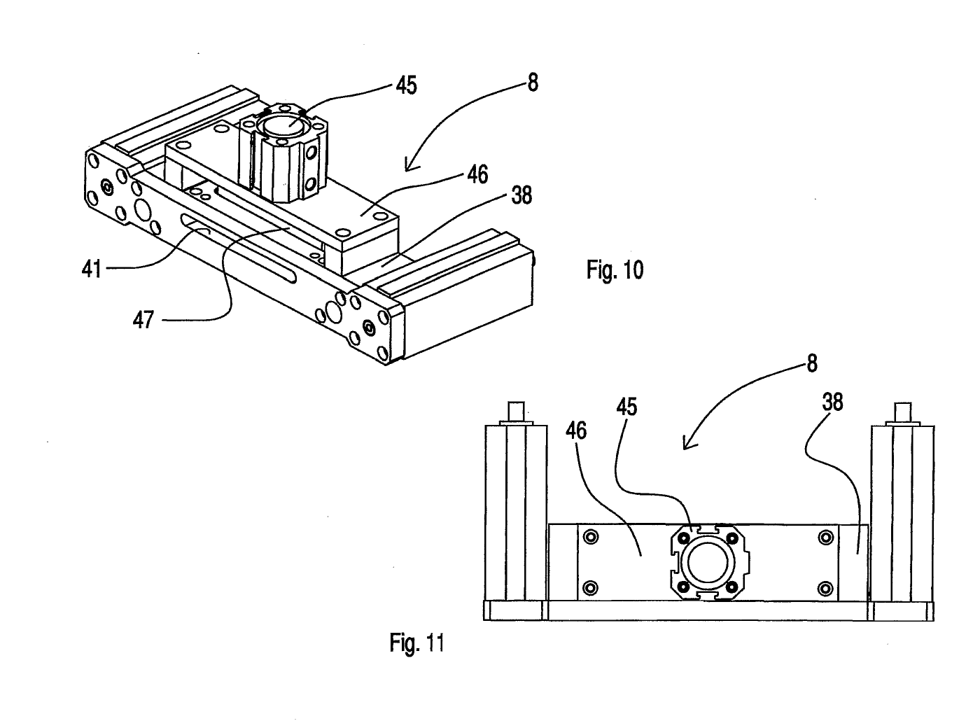

The guide means 8, shown in FIGS. 9 to 11 is designed to guide the tubes 80 along a direction of feed G substantially parallel with the first axis X. The guide means 8 comprises a first slide 38 extending along a direction substantially parallel with the second axis Y. A pair of first through holes 39 enables the first slide 38 to move along the rods 37, as described in more detail below. The guide means 8 further comprises a first central portion 40 having in it a through slot 41 extending in a direction parallel with the second axis Y and being substantially elliptic in shape to enable a plurality of tubes 80 to slide in it. The guide means 8 also comprises a first guide element 42 located substantially in correspondence with the first central portion 40 and equipped with a plurality of first grooves 43 extending parallel with the first axis X and each designed to accommodate a tube 80 of supporting elements 2. Each first groove 43 has guide protrusions 44 designed to engage the respective cavity 13 of the tube 80 in such a way as to position the latter as required in the working area 24.

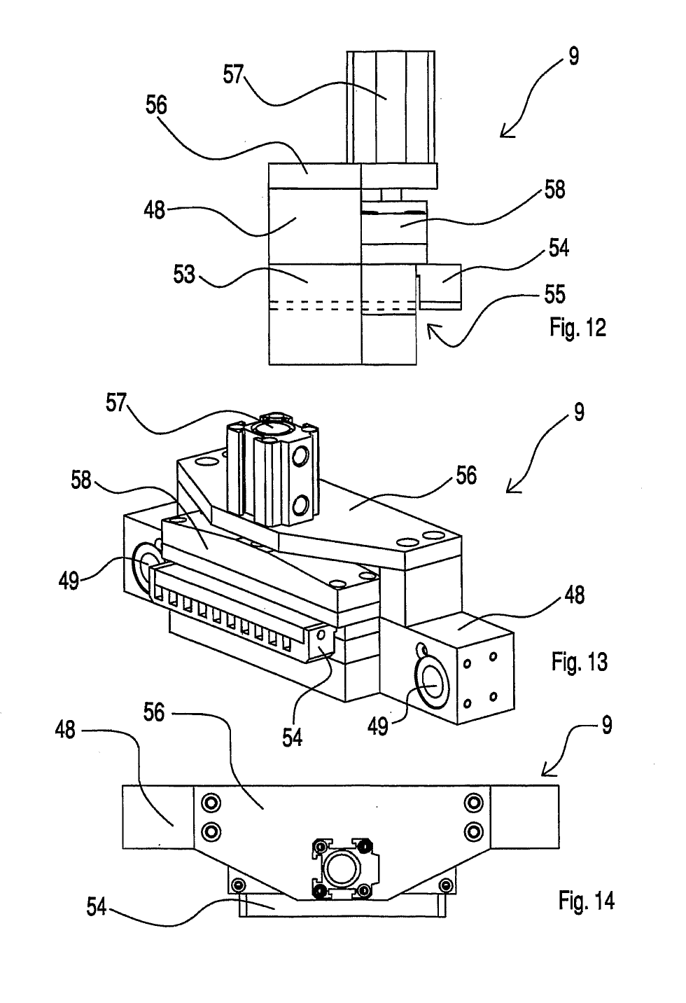

The guide means 8 yet further comprises a second crossbar 46 with which a first actuator 45, for example, of the pneumatic type, is associated. The first actuator 45 is associated with an engagement element 47 having, for example, the shape of a parallelepiped with rectangular base, and is designed to move the latter along an axis substantially parallel with the third axis Z between a second engaged position and a second released position for engaging/releasing the tubes 80, respectively, as described in more detail below. In other words, in the second engaged position, the engagement element 47 is in contact with the tubes 80, whilst in the second released position, the engagement element 47 is raised relative to the tube 80. Inserting means 9 is positioned downstream of the guide means 8 in the feed direction G, said means 9 is provided for inserting the tags 6 into the respective housings 5 in the tubes 80. The inserting means 9, shown in FIG. 8 and in FIGS. 12 to 14, comprises a second slide 48 extending in a direction parallel with the second axis Y and running, by means of a pair of second through holes 49, along the rods 37, as described in more detail below. The inserting means 9 also comprises a second central portion 50 having a second guide element 51 with a plurality of second grooves 52. The second grooves 52, facing the first grooves 43, extend in a direction parallel with the first axis X and are designed to accommodate one tube 80 of supporting elements 2 each.

The second guide element 51 comprises a first part 53 and a second part 54, the second part 54 being designed to accommodate a tube 80 end portion 81 whose length, measured along the first axis X, is substantially equal to the length of the tags 6, and said second part 54 being positioned downstream of the first part 53 in the feed direction G. Between the first part 53 and the second part 54 there is an indentation 55 extending along the second axis Y and designed to be crossed by cutting means 12a, 12b which cut the supporting elements 2 to a required length, as described in more detail below.

The inserting means 9 further comprises a third crossbar 56 with which a second actuator 57, for example, of the pneumatic type, is associated. The second actuator 57 is associated with a support 58 mounting a plurality of pointed elements 59 arranged in a row and suitably spaced in a direction parallel with the second axis Y. More specifically, the pointed elements 59 are positioned in proximity and upstream, in the feed direction G, of the indentation 55 that defines a cutting line for the tubes 80. The second actuator 57 is designed to move the support 58 along an axis substantially parallel with the third axis Z between a third released position H, shown in FIG. 8, and a third engaged position, not illustrated, where the pointed elements 59 respectively release and engage the tubes 80, as described in more detail below. In other words, in the third engaged position, the pointed elements 59 are inserted at least partially in the tubes 80, whereas in the third released position H, the pointed elements 59 are raised relative to the tubes 80.

The assembling machine 1 further comprises drive means 60, shown in FIGS. 1 and 25, for driving the guide means 8 and the inserting means 9 slidably along the rods 37. The drive means 60 comprises first drive means 64 and second drive means 65 positioned laterally and on the outside of the rods 37. Looking in more detail, the first to drive means 64 and the second drive means 65 are each associated at one end 61 with the guide means 8 and, at their further end 62, opposite the end 61, with a bar 63, for example, a threaded bar, which is in turn associated with a hole, not illustrated, made in a respective support 34. The first drive means 64 and the second drive means 65 each comprise a body 66 internally provided with a first and a second chamber, not illustrated, designed to accommodate first actuating means 200 and second actuating means 201, for example, of the pneumatic type.

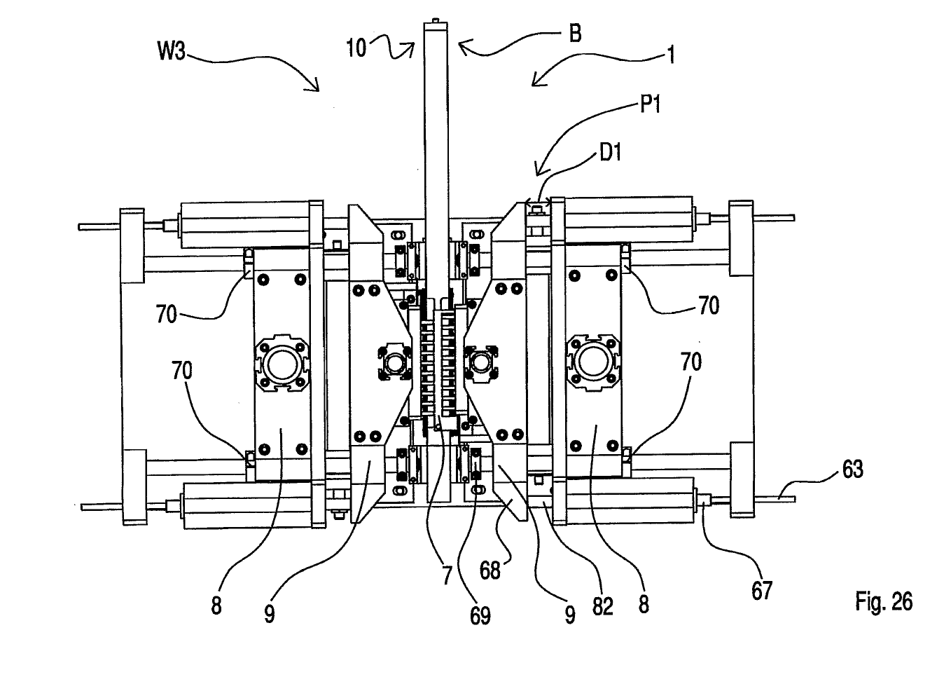

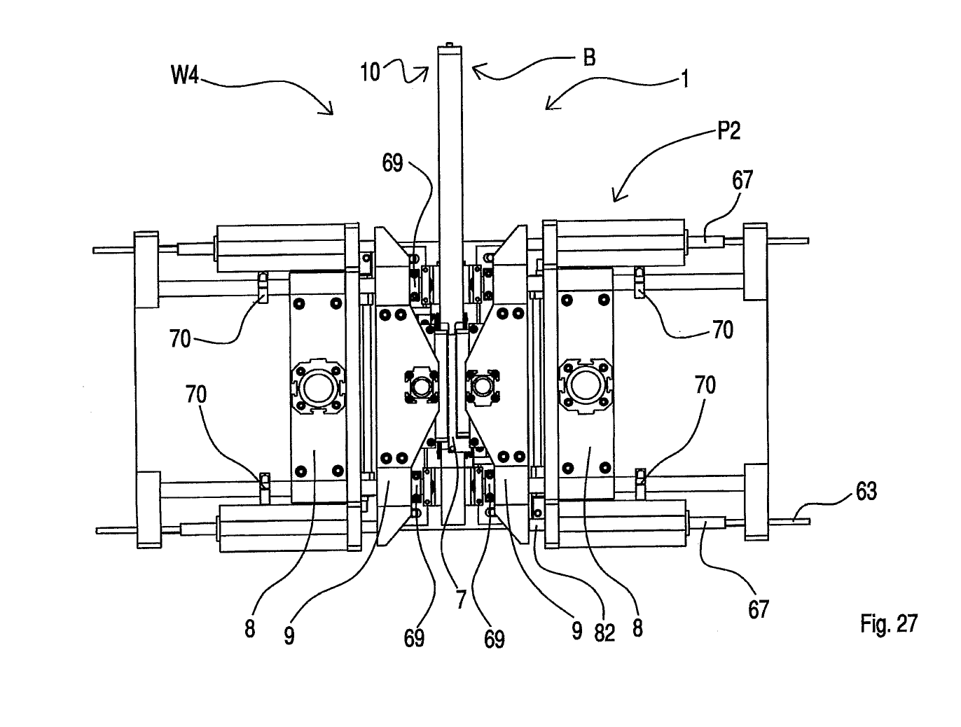

The first actuating means 200 comprises a first rod 82 (FIG. 26) associated at one end of it with fixing elements 68 of the inserting means 9, while the second actuating means 201 comprises a second rod 67 (FIGS. 24-27) associated at one end of it with the bar 63. The assembling machine 1 also comprises first limit stop means 69 and second limit stop means 70, each comprising, for example, a pair of rings that can be associated with the rods 37, and designed to define respectively a first end limit position (FIG. 27) for the inserting means 9, and a second end limit position (FIGS. 24-26) for the guide means 8.

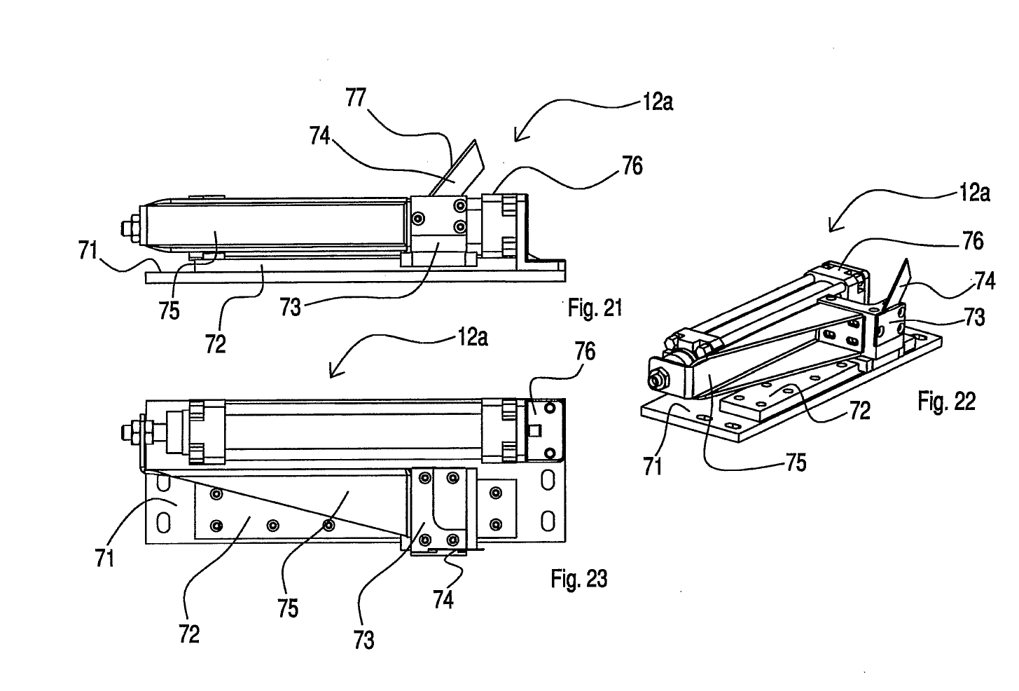

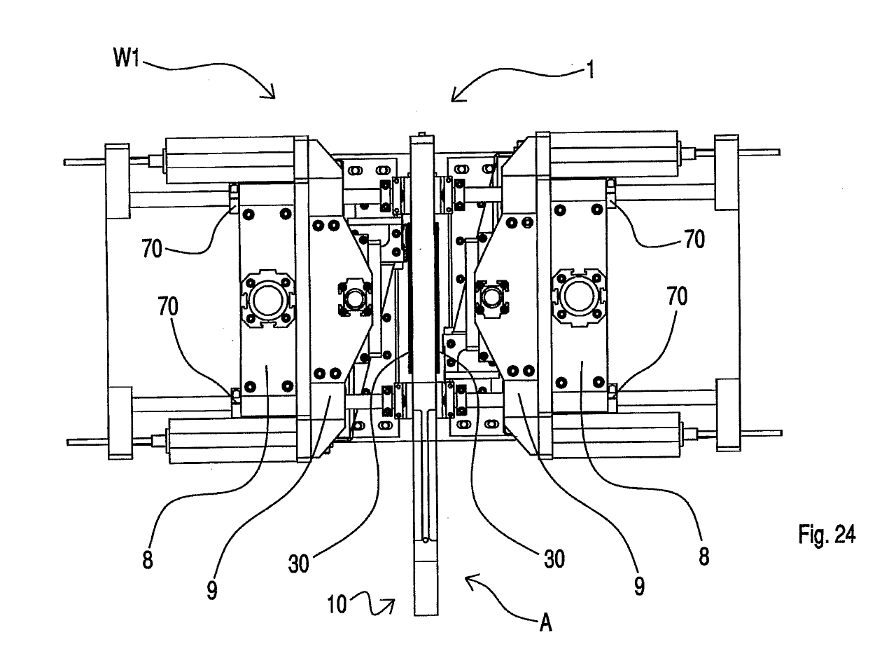

As stated above, the assembling machine 1 further comprises means 12a and 12b for cutting the supporting elements 2 to the required length. The cutting means 12a and 12b comprise first cutting means 12a, illustrated in detail in FIGS. 21 to 23, and second cutting means 12b positioned respectively on opposite sides of the supporting means 10 and under the inserting means 9. The first cutting means 12a comprise a mounting plate 71 associated with the frame 3 and mounting a guide 72 on which a carriage 73 runs. The carriage 73 mounts a blade 74, having a cutting edge 77 and which, in use, slides along the indentation 55 of the inserting means 9. The carriage 73 is associated, by means of a connecting element 75, with a third actuator 76, for example, of the pneumatic type.

The third actuator 76 is designed to move the blade 74 to and from in a direction parallel with the second axis Y along a forward stroke, during which the blade cuts the tubes 80, and a return stroke. The second cutting means 12b is functionally and substantially similar to the first cutting means 12a and is not therefore described.

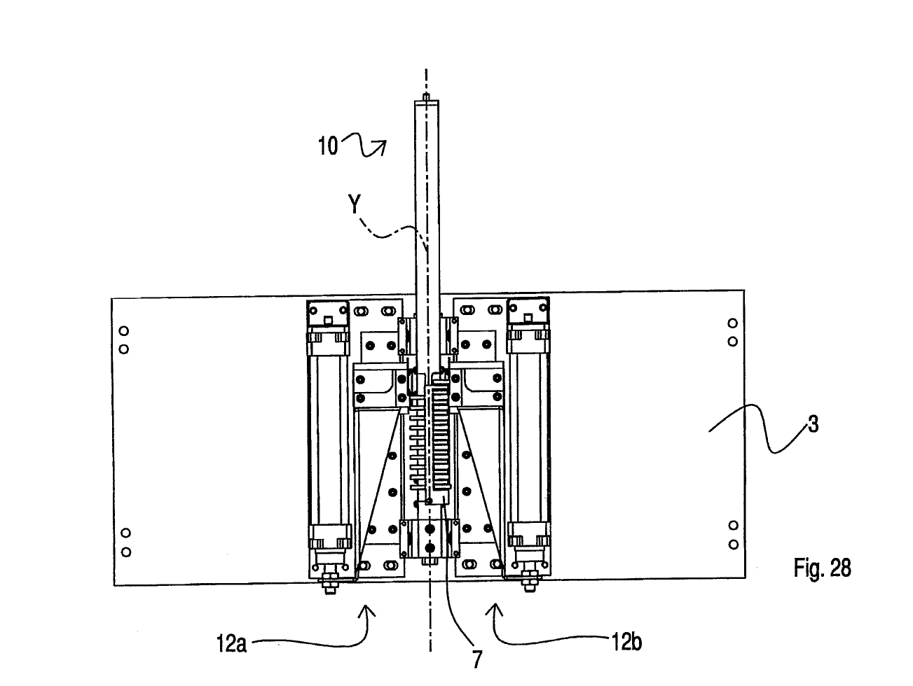

It should be noticed that the first cutting means 12a and the second cutting means 12b are mounted on the frame 3 in such a way that their blades 74 move in opposite directions during the respective forward and return strokes. In another embodiment, shown in FIG. 28, the first cutting means 12a and the second cutting means 12b are mounted on the frame 3 in such a way that their blades 74 move in the same direction during the respective forward and return strokes. Below is a description of the operation of the assembling machine 1 with reference to the right-hand portion of FIGS. 24 to 27.

FIG. 24 shows the assembling machine 1 in a first operating configuration W1 where a strip 7 of tags 6 can be placed on the supporting means 10 or where a strip 7, in which the supporting elements 2 have already been fitted around the tags 6, can be removed from the supporting means 10. In the first operating configuration W1 the supporting means 10 are positioned in the first working position A, the presser 28, not shown, is in the first released position and the positioning means 11 is lowered. Further, in the first operating configuration W1, the second actuating means 201 keeps the guide means 8 in contact with the second limit stop means 70, while the first actuating means 200 keeps the inserting means 9 in contact with the guide means 8. Moreover, in the first operating configuration W1, the engagement element 47 is in the second released position, while the pointed elements 59 are in the third engaged position, i.e., the pointed elements 59 are inserted at least partially in the tubes 80. FIG. 25 shows the assembling machine 1 in a second operating configuration W2 where the strip 7 is positioned in the working area 24. In the second operating configuration W2 the supporting means 10 are positioned in the second working position B, the presser 28, not shown, is in the first engaged position and the positioning means 11 are raised.

Further, in the second operating configuration W2, the second actuating means 201 keeps the guide means 8 in contact with the second limit stop means 70, while the first actuating means 200 keeps the inserting means 9 in contact with the guide means 8, Moreover, in the second operating configuration W2, the engagement element 48 is in the second released position, while the pointed elements 59 are in the third engaged position, that is to say, the pointed elements 59 are inserted at least partially in the tubes 80.

FIG. 26 shows the assembling machine 1 in a third operating configuration W3 where the tags 6 are partly inserted into the tube 80 end portions 81 accommodated in the second part 54 of the second guide elements 51 of the inserting means 9. In the third operating configuration W3 the supporting means 10 are positioned in the second working position B, the presser 28, not shown, is in the first engaged position and the positioning means 11 is raised, Further, in the third operating configuration W3, the second actuating means 201 keeps the guide means 8 in contact with the second limit stop means 70, while the first actuating means 200 positions the inserting means 9 in a first position P1.

In the first position P1 the inserting means 9 are moved away from the guide means 8 by a first distance D1, measured along the first axis X, long enough to partly insert the tags 6 into the end portions 81 of the tubes 80. Moreover, in the third operating configuration W3, the engagement element 47 is held in the second released position, while the pointed elements 59 are in the third engaged position, that is to say, the pointed elements 59 are inserted at least partially in the tubes 80. In this way, the tubes 80 can be made to advance in the feed direction G by a length equal to the distance D1 relative to the guide means 8.

FIG. 27 shows the assembling machine 1 in a fourth operating configuration W4 where the tags 6 are fully inserted into the end portions 81 of the tubes 80. In the fourth operating configuration W4 the supporting means 10 are positioned in the second working position B, the presser 28, not shown, is in the first released position and the positioning means 11 is lowered, Further, in the fourth operating configuration W4, the second actuating means 201 positions the guide means 8 in a second position P2 away from the respective supports 34. In the second position P2 the second actuating means 201 moves the inserting means 9 into contact with the first limit stop means 69. Thus, the inserting means 9 inserts the tags 6 fully into the end portions 81 of the tubes 80. Moreover, in the fourth operating configuration W4, the engagement element 47 is held in the second released position, while the pointed elements 59 are in the third engaged position, that is to say, the pointed elements 59 are inserted at least partially in the tubes 80. The pointed elements 59 are then moved into the third released position H, in such a way as to release the tube 80 so that it can return elastically.

Next, the pointed elements 59 are moved into the third engaged position and the first and second cutting means 12a and 12b are driven to cut respective opposite rows of supporting elements 2 fitted with respective tags 6. Next, the pointed elements 59 are moved into the third released position, i.e., the pointed elements 59 are not inserted in the tubes 80, and the engagement element 47 is moved into the second engaged position. Next, the first actuating means 200 are driven to move the inserting means 9 into contact with the guide means 8, while the latter is held in the second position P2 by the second actuating means 201. After that, the pointed elements 59 are moved into the third engaged position and the engagement element 47 is moved into the second released position.

Next, the second actuating means 201 is driven to move the guide means 8 into contact with the second limit stop means 70, while the first actuating means 200 holds the inserting means 9 in contact with the guide means 8. The presser 28 can now be moved into the first released position and the supporting means 10 into the first working position A in order to respectively remove the strip 7 on which the supporting elements 2 have already been fitted around the tags 6 and to insert another strip 7 on which the supporting element 2 inserting operation can be repeated. It should be noticed that the invention contemplates the provision of a plurality of pointed element 59 mounting units 58, of first elements 42 for guiding the guide means 8 and of second elements 51 for guiding the inserting means 9, which can be mounted on the assembling machine 1 as needed, in accordance with the size of the strip 7 and of the tubes 80.

Moreover, in accordance with the size of the tags 6, it is also possible to change the positions of the first and second limit stop means 69 and 70 on the rods 37, as well as the positions of the second rods 67 along the bars 63. More specifically, the bars 63 are designed to permit adjustment of the second position P2 of the guide means 8 along the rods 37. It should also be noticed that the assembling machine 1 described above is symmetrical about the supporting means 10, which considerably increases the productivity of the machine itself.

1-68. (canceled)

69. A machine for assembling modular markers for identifying electric cables, the markers including tags and supporting elements, said supporting elements having respective housings for accommodating said tags, and a respective cavity for accommodating an electric cable or the like, the machine comprising:
a frame extending along a first axis, said frame having means for supporting the tags extending along a second axis; and
means for inserting the housings of the supporting elements onto the tags along a feed direction.

70. The machine according to claim 69, wherein said tags are grouped in strips comprising a plurality of tags and said supporting means comprises a mounting element having a seat for mounting a strip of tags.

71. The machine according to claim 70, wherein said mounting element defines a first working position where said strip of tags is insertable into said seat of the mounting element, or where said strip, on which the supporting elements have already been fitted around the tags, is removable from said seat.

72. The machine according to claim 70, wherein said mounting element defines a second working position where said strip is positioned in a working area of said machine in which the markers are assembled.

73. The machine according to claim 72, comprising retaining means for engaging or releasing the strip of tags.

74. The machine according to claim 73, wherein said retaining means defines an engaged position in which the strip of tags is held in said seat when the mounting element is in the second working position, and a released position in which the strip is releasable from the seat, when said mounting element is in said second working position.

75. The machine according to claim 74, wherein said retaining means comprises a presser facing said tags when the supporting means is in said second working position.

76. The machine according to claim 69, wherein said inserting means comprises slide means including a guide element for guiding a plurality of tubes of supporting elements along said feed direction.

77. The machine according to claim 76, wherein said tube of supporting elements has an end portion and said guide element has a seat for accommodating the tube end portion for a length that is substantially equal to the length of said tags.

78. The machine according to claim 77, wherein said guide element has a first part and a second part, between said first part and said second part is provided an indentation, which extends along said second axis and defining a cutting line for said tubes of supporting elements.

79. The machine according to claim 69, wherein said inserting means comprises a support for mounting a plurality of engagement elements for holding said tubes in said seat.

80. The machine according to claim 79, wherein said engagement elements define a released position where the engagement elements release the tube end portion, and an engaged position where the engagement elements hold said tube end portion in said seat.

81. The machine according to claim 81, wherein said engagement elements comprise a plurality of pointed elements.

82. The machine according to claim 76, comprising guide means located upstream of said inserting means in said feed direction for guiding the tubes along said feed direction towards said inserting means.

83. The machine according to claim 82, wherein said guide means comprises further slide means extending in a direction substantially parallel with said second axis and running on said sliding means.

84. The machine according to claim 83, wherein said further slide means comprises a further guide element for guiding said tubes along the feed direction.

85. The machine according to claim 84, wherein said further guide element comprises a plurality of further grooves extending in a direction substantially parallel with said feed direction.

86. The machine according to claim 85, wherein said guide means comprises protrusions, each of said protrusions being located in one of said further grooves and being provided for engaging the respective cavity of said tube in such a way as to position said tubes.

87. The machine according to claim 86, wherein the guide means comprises an engagement element for holding said tubes in place.

88. The machine according to claim 87, wherein said engagement element defines an engaged position where it holds said tubes in place, and a released position where it releases said tubes.

89. A machine for assembling modular markers for identifying electric cables, the markers including tags and supporting elements, said supporting elements having respective housings for accommodating said tags, the machine comprising:
a frame extending along a first axis, said frame having means for supporting the tags extending along a second axis;
means for inserting the housings onto the tags along a feed direction, said means for inserting being associated with the frame and including:
sliding means having a guide element for guiding a plurality of tubes of supporting elements along said feed direction; and
means for cutting the tubes, with the tags positioned inside the housings of the tubes, to a length.

90. The machine according to claim 89, wherein the cutting means comprises a mounting plate associated with the frame of the machine and carrying a further guide on which a carriage runs to and from.

91. The machine according to claim 90, wherein the guide element comprises an indentation and the carriage is associated with a blade that slides in the indentation in the guide element in such a way as to cut the tubes.

92. The machine according to claim 89, comprising positioning means for placing the tags in a suitable position on the supporting means.

93. The machine according to claim 92, wherein the positioning means comprises a positioning element movable along the third axis between a raised position and a lowered position in which it is, respectively, in contact with, and at a certain distance from, the tags.

94. The machine according to claim 93, wherein said positioning element is substantially U-shaped and, at its ends, has substantially coplanar contact portions each designed to come into contact with one row of tags on the strip.

95. A machine for assembling modular markers for identifying electric cables, the markers including tags and supporting elements, said supporting elements having respective housings for accommodating said tags, and a respective cavity for accommodating an electric cable or the like, the machine comprising:
a frame extending along a first axis, said frame having means for supporting the tags extending along a second axis;
means for inserting the housings onto the tags along a feed direction, said means for inserting being associated to the frame and including sliding means having a guide element for guiding a plurality of tubes of supporting elements along said feed direction;
means for cutting the tubes, with the tags positioned inside the housings of the tubes, to a length, wherein said first axis, second axis and third axis are substantially perpendicular to each other; and
positioning means including a positioning element movable along a third axis between a raised position and a lowered position in which it is, respectively, in contact with, and at a certain distance from, the tags.
